(19) United States
(12) Patent Application Publication
(10) Pub. No.: US 2012/0282475 A1
(43) Pub. Date: Nov. 8, 2012

(54) NON-AQUEOUS DISPERSIONS COMPRISING A POLYESTER STABILIZER AND THEIR USE IN COATINGS

(75) Inventors: Mary Ann M. Fuhry, Butler, PA (US); John M. Dudik, Apollo, PA (US); Christopher P. Kurtz, Pittsburgh, PA (US)

(73) Assignee: PPG Industries Ohio, Inc., Cleveland, OH (US)

(21) Appl. No.: 13/101,366

(22) Filed: May 5, 2011

(51) Int. Cl. B32B 15/08; C09D 133/14

(52) U.S. Cl. 428/461; 524/502

(57) ABSTRACT

A non-aqueous dispersion comprising the dispersion polymerization reaction product of an ethylenically unsaturated monomer and a polyester stabilizer in solvent is disclosed, as are coatings comprising the same and substrates coated at least in part with such coatings.

### FIELD OF THE INVENTION

The present invention relates to a non-aqueous dispersion comprising the dispersion polymerization reaction product of an ethylenically unsaturated monomer and a polyester stabilizer, and the use of these dispersions in coatings.

### BACKGROUND INFORMATION

The application of various polymeric coatings to metallic substrates, including metal food and beverage containers, to retard or inhibit corrosion is well established. Coatings are applied to the interior of such containers to prevent the contents from contacting the metal of the container. Contact between the metal and the food or beverage can lead to corrosion of the metal container, which can then contaminate the food or beverage. This is particularly true when the contents of the container are acidic in nature, such as tomato-based products and soft drinks. The coatings applied to the interior of food and beverage containers also help prevent corrosion in the head space of the containers, which is the area between the fill line of the food product and the container lid; corrosion in the head space is particularly problematic with food products having a high salt content.

In addition to corrosion protection, coatings for food and beverage containers should be non-toxic, and should not adversely affect the taste of the food or beverage in the can. Resistance to “popping”, “blushing” and/or “blistering” is also desired.

Various epoxy-based coatings and polyvinyl chloride-based coatings have been used in the past to coat the interior of metal cans to prevent corrosion. The recycling of materials containing polyvinyl chloride or related halide-containing vinyl polymers can generate toxic by-products, however; moreover, these polymers can be formulated with epoxy-functional plasticizers. Typically, epoxy-based coatings are prepared from monomers such as bisphenol A (“BPA”) and bisphenol A diglycidylether (“BADGE”), which are being reported as having negative health effects. While attempts have been made to scavenge the residual unreacted monomer with, for example, acid functional polymers, this does not always adequately address the problem; some free BPA, BADGE or their by-products may still remain. Government authorities, particularly in Europe and Canada, are restrictive on the amount of free BPA, BADGE and/or their by-products that are acceptable. Thus, there is a need for food and beverage can coatings that have acceptable flexibility, adhesion to metal, and/or corrosion resistance and that are substantially free from BPA, BADGE, and, in some cases, other products.

### SUMMARY OF THE INVENTION

The present invention is directed to a non-aqueous dispersion comprising a) the dispersion polymerization reaction product of an ethylenically unsaturated monomer and a polyester stabilizer, and b) an organic solvent. Coatings comprising such a non-aqueous dispersion and substrates coated with the same are also within the present invention.

### DETAILED DESCRIPTION OF THE INVENTION

The present invention is generally directed to non-aqueous dispersions comprising a polyester stabilizer. The term “polyester stabilizer” as used in the context of the present invention refers to a polymer that comprises 50 weight percent or greater polyester, such as 75 weight percent or greater, or 95 weight percent or greater of polyester. In certain embodiments the stabilizer comprises 100 weight percent polyester. A wide variety of polyesters can be used as a stabilizer according to the present invention. The polyester stabilizer of the present invention has ethylenic unsaturation, which can be introduced by any method known in the art, such as by incorporating a polyol and/or polyacid/anhydride having ethylenic unsaturation, or by reacting some of the acid functionality of the polyester with a compound having ethylenic unsaturation, such as an epoxy-functional (meth)acrylate an example of which is glycidyl methacrylate.

Typically, the weight average molecular weight (“Mw”) of the polyester will range from 3,000 to 30,000, such as 5,000 to 25,000, or 7,000 to 18,000. The polyester will typically have a hydroxy value of from 40 to 300 mg KOH/g resin, such as from 100 to 250 mg KOH/g resin, and an acid value of from 2 to 50 mg KOH/g resin, such as from 35 to 50 mg KOH/g resin.

The polyester stabilizer can be prepared from polyols and polycarboxylic acids and/or anhydrides using methods known to those skilled in the art. A polyol will be understood by those skilled in the art as a compound having two or more hydroxyl groups. Suitable polyols can include ethylene glycol; 1,2- and 1,3-propanediol; 2-methyl-1,3-propanediol; 1,3- and 1,4-butanediol; 1,6-hexanediol; 1,4-cyclohexane dimethanol; isosorbide; tricyclodecane dimethanol; neopentyl glycol; trimethylolpropane; glycerin; and pentaerythritol.

In some embodiments, polyols of higher functionality, that is, polyols having three or more OH groups, may be used to provide branching along the polyester backbone. Examples include trimethylolpropane, trimethylolethane, pentaerythritol, tris-hydroxyethylisocyanurate and the like. It will be appreciated that polymer branching can be quantified using the Mark-Howink parameter. In certain embodiments, the Mark-Howink parameter of the present polyester stabilizers as measured by triple detector GPC is 0.3-0.7, such as 0.4-0.6. In some embodiments, the level of higher functionality polyol is greater than 10%, such as greater than 50%, or up to 100%, of the polyol component of the polyester composition.

Any suitable mono- or polycarboxylic acid/anhydride can be used according to the present invention. It will be understood by those skilled in the art that a polycarboxylic acid is one that has two or more acid functional groups, or derivatives thereof, such as anhydride groups. Suitable monocarboxylic acids include benzoic acid and its derivatives, 2-ethylhexanoic acid, and the like. Suitable polycarboxylic acids/anhydrides include phthalic acid/anhydride, hexahydrophthalic acid/anhydride, adipic acid/anhydride, cyclohexanedicarboxylic acid, isophthalic acid, terephthalic acid, trimellitic anhydride, the C36 dimer fatty acids, maleic acid/anhydride, and fumaric acid/anhydride.

In one embodiment, at least some of the mono- or polycarboxylic acid and/or anhydride comprises a polymerizable double bond. Suitable monocarboxylic acids comprising a polymerizable double bond include (meth)acrylic acid and its esters. Suitable polycarboxylic acids/anhydrides comprising a polymerizable double bond include maleic acid, fumaric acid, trimethyolol propane monoallyl ether, and itaconic acid, and anhydrides of any of these. The polycarboxylic acid and/or anhydride comprising a polymerizable double bond may be reacted into the polyester composition at the same time as the other components, or it may be reacted with the polyester after the polyester has been formed from the other components. For example, a polyester can be prepared from 1,4-cyclohexane dimethanol, C36 dimer fatty acid, and trimethylolpropane, and then reacted with maleic anhydride; it will be understood that a polyester prepared from such monomers will comprise ethylenic unsaturation, and that the ethylenic unsaturation will make the polyester reactive towards free radical polymerization.

In certain embodiments, the polyester is substantially free of substructures such as those shown in Figure A, where “R” is a terminal, nonfunctional hydrocarbon chain of greater than 8, such as greater than 12, carbon atoms. By “nonfunctional” is meant that the terminal hydrocarbon chain does not contain functional groups such as hydroxyl or carboxylic acid groups. “Substantially free of” in this context means 10 weight percent or less, such as 5 weight percent or less, of such terminal, nonfunctional hydrocarbon chains based on total solids weight of the polyester.

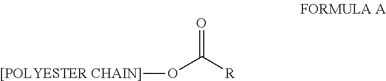

The polyester stabilizer is typically compatible with the continuous phase of the non-aqueous dispersion. The continuous phase can be an organic solvent, including a mixture of such solvents. The solvent(s) are chosen so that the polyester stabilizer is soluble or nearly soluble in the continuous phase. This can usually be determined based on the carbon to oxygen ratio, which can be calculated on the mole ratio of the monomers minus the water of esterification. For example, if the carbon to oxygen ratio of the polyester is from 3.0 to 6.0, such as from 4.0 to 5.0, a suitable continuous phase can comprise a blend of butyl acetate, 1-methoxy-2-propanol, and ISOPAR K.

In the present invention, the polyester stabilizer is further reacted with a monomer, including a mixture of monomers, comprising ethylenic unsaturation. These monomers are sometimes referred to herein as the “core monomers” and, upon polymerization, form the “core polymer”. The core monomer(s) and the stabilizer react through the ethylenic unsaturation by dispersion polymerization techniques, which are known to those skilled in the art. For example, the stabilizer may be dissolved in a suitable solvent or mixture of solvents, and the core monomer(s) may be added to the solution at an elevated temperature over a period of time, during which a radical initiator is also added to the mixture. It will be appreciated by those skilled in the art that, in addition to the polymerization of the core monomer(s) with other core monomer(s), at least some of the polymerizable double bonds of the polyester will react with some of the core monomer(s) under these conditions. Through this process, the core polymer will become grafted, that is, covalently bonded, to the polyester. The core monomer(s) may be added in a single timed feed, or they may be added in stages, such as in two stages. The composition of the monomers may be the same or different when added either at the same time or different times. Suitable core monomers include methyl(meth)acrylate, ethyl(meth)acrylate, n-butyl(meth)acrylate, isobutyl(meth)acrylate, 2-ethylhexyl(meth)acrylate, isobornyl(meth)acrylate, 2-hydroxyethyl(meth)acrylate, 2-hydroxypropyl(meth)acrylate, (meth)acrylic acid, glycidyl(meth)acrylate, styrene, alpha-methylstyrene, lauryl(meth)acrylate, stearyl(meth)acrylate, itaconic acid and its esters, and the like. As used herein, and as is conventional in the art, use of “(meth)” refers to both acrylate, acrylic acid and the like as well as the corresponding methacrylate, methacrylic acid and the like.

In certain embodiments the monomers comprise a poly-ethylenically unsaturated monomer. A poly-ethylenically unsaturated monomer is a monomer that has two or more polymerizable double bonds, such as hexanediol diacrylate, ethylene glycol dimethacrylate, trimethylol propane triacrylate, or divinylbenzene. In other embodiments, two or more coreactive monomers may be used, such as glycidyl methacrylate and acrylic acid. In yet other embodiments, the monomers are substantially free of amine functional monomers. The reaction of the polyester stabilizer with the “core” monomer(s) by the dispersion polymerization technique described above provides the dispersion polymerization reaction product of the present invention. The weight percent of the polyester stabilizer can be from 50% to 95%, such as from 60% to 90%, of the weight of the total composition of dispersion polymerization reaction product.

In addition to the polyester stabilizer being soluble or nearly soluble in the continuous phase, the relative solubility parameters of the continuous phase and the core polymer may also be considered. In certain embodiments, the solubility parameter of the core polymer at 298 K is 17 to 28 (J/cc)̂(0.5), such as 19 to 25 (J/cc)̂(0.5). The solubility parameter of the core polymer as stated herein is calculated using Synthia implemented in Material Studio 5.0, available from Accelrys, Inc., San Diego, Calif. Solubility parameters for individual solvents can be obtained, for example, from “Hansen Solubility Parameters: a User's Handbook”, Charles M. Hansen, CRC Press, Inc., Boca Raton Fla., 2007. The solubility parameter of the solvent blend is calculated from the weighted average of the solubility parameter of the individual solvents. As used in reference to solubility parameter, “units” refers to (J/cc)̂(0.5). In certain embodiments, the solubility parameter of the solvent blend is lower than that of the core monomers, such as a difference of 4.0 units or greater, or 5.0 units or greater; in these embodiments, if there is less than a 4.0 unit difference the core monomers may be too soluble in the continuous phase and a dispersion may not readily form.

The non-aqueous dispersions of the present invention may comprise functionality, such as hydroxyl functionality and/or acid functionality. In certain embodiments, the theoretical hydroxyl value of the non-aqueous dispersion can be from 40 to 350 mg KOH/g resin, such as from 60 to 280 mg KOH/g resin, or from 100 to 280 mg KOH/g resin. In certain embodiments, the theoretical acid value may be from 0 to 80 mg KOH/g resin, such as from 5 to 80 mg KOH/g resin or 10 to 80 mg KOH/g resin.

It will be appreciated by those skilled in the art that the reaction of the core monomer(s) with the stabilizer to yield the dispersion polymerization reaction product will result, in certain embodiments, in a microparticle. The weight average molecular weight of the non-aqueous dispersion as measured by gel permeation chromatography against a linear polystyrene can be very high, such as100,000 g/mol, or can be so high as to be immeasurable due to gel formation within the particle. The microparticle size may be measured by standard methods, such as by light scattering or LASER diffraction. The non-aqueous dispersions of the present invention typically have microparticle sizes of 0.20 to 4.00 microns, such as 0.20 to 2.00 microns, as measured by light scattering on a Malvern MASTERSIZER instrument. In certain embodiments, having microparticles with high gel content may, when used in a coating, contribute to one or more enhanced properties, such as improved appearance, and/or resistance to solvents, acids and the like.

The dispersion polymerization reaction product of the present invention may be internally crosslinked or uncrosslinked. Crosslinked non-aqueous dispersions may be desired in certain embodiments over uncrosslinked non-aqueous dispersions because uncrosslinked materials are more likely to swell or dissolve in the organic solvents that are commonly found in many of the coating compositions to which the dispersions are subsequently added. Crosslinked non-aqueous dispersions may have a significantly higher molecular weight as compared to uncrosslinked dispersions. Crosslinking of the non-aqueous dispersion can be achieved, for example, by including a polyfunctional ethylenically unsaturated monomer (or a crosslinking agent) with the ethylenically unsaturated monomer or monomer mixture during polymerization. The polyfunctional ethylenically unsaturated monomer can be present in amounts of 0 to 20% by weight based on the total weight of monomers used in preparing the non-aqueous dispersion, such as from 1 to 10% by weight.

In certain embodiments, the core monomer(s) of the dispersion polymerization reaction product comprise less than 90% by weight of a polar and/or functional monomer. The term “polar” as used herein refers to acrylic monomers or compounds that have a solubility parameter (van Krevelen) at 298 K of 19 MPâ0.5 or more. Conversely, the term “non-polar” describes substances that have a solubility parameter (van Krevelen) at 298 K lower than 19 MPâ0.5. A polar core monomer can be, for example, 2-hydroxyethyl methacrylate.

As noted above, the non-aqueous dispersions described herein further include an organic solvent. Any suitable solvent can be used including an ester, ketone, glycol ether, alcohol, hydrocarbon or mixtures thereof. Suitable ester solvents include alkyl acetates such as ethyl acetate, n-butyl acetate, n-hexyl acetate, and mixtures thereof. Examples of suitable ketone solvents include methyl ethyl ketone, methyl isobutyl ketone, and mixtures thereof. Examples of suitable hydrocarbon solvents include toluene, xylene, aromatic hydrocarbons such as those available from Exxon-Mobil Chemical Company under the SOLVESSO trade name, and aliphatic hydrocarbons such as hexane, heptanes, nonane, and those available from Exxon-Mobil Chemical Company under the ISOPAR and VARSOL trade names. In certain embodiments the solvent is volatile. In certain other embodiments the solvent is not an alkyd and/or any other fatty acid containing compound.

It will be appreciated by those skilled in the art that the non-aqueous dispersions of the present invention are distinct from latex, which are aqueous dispersions. The present non-aqueous dispersions are also distinct from solution polymers, in that the non-aqueous dispersions have a dispersed phase that is different from the continuous phase, while a solution polymer has a single, homogeneous phase.

The non-aqueous dispersions of the present invention do not form homogeneous solutions. They are characterized by discrete particles that are dispersed in a separate, continuous phase, referred to above as microparticles. The present non-aqueous dispersions may appear translucent or opaque, as is characteristic of dispersions.

A “non-aqueous dispersion” as used herein is one in which 75% or greater, such as 90% or greater, or 95% or greater of the dispersing media is a non-aqueous solvent, such as any of those listed above. Accordingly, a non-aqueous dispersion can still comprise some level of aqueous material, such as water.

Any of the non-aqueous dispersions described herein can be further used in a coating. The non-aqueous dispersions of the present invention can form part of the coating film. In some embodiments, the non-aqueous dispersion can be the main film former, while in other embodiments it can be used as an additive. In some embodiments the non-aqueous dispersion may be crosslinked into the film to form a thermoset coating as discussed below.

The coating compositions can further comprise a crosslinking agent. In certain embodiments, the crosslinking agent will react with the non-aqueous dispersions to form a film. Suitable crosslinking agents can be chosen by those skilled in the art based upon the chemistry of the non-aqueous dispersion and may include, for example, aminoplast crosslinkers, phenolic crosslinkers, or blocked or unblocked isocyanates Aminoplast crosslinkers can be melamine based, urea based or benzoguamine based. Melamine cross linkers are widely commercially available, such as from Cytec Industries, Inc., in their CYMEL line. Phenolic crosslinkers include, for example, novolacs and resoles. For use on food cans, phenolic resoles that are not derived from bisphenol A are particularly suitable. In certain embodiments, lower amounts of crosslinker than are typically used with polyester-containing systems can be used according to the present invention while still achieving suitable performance. For example, coatings comprising the nonaqueous dispersion of the present invention may comprise 50 weight percent or lower of crosslinker, such as phenolic crosslinker, or even 40 weight percent or lower, 30 weight percent or lower, or 25 weight percent or lower. This weight percent is based on total solids weight.

It will be appreciated that in certain embodiments the non-aqueous dispersion of the present invention and crosslinker therefor can form all or part of the film-forming resin of the coating. In certain embodiments, one or more additional film-forming resins are also used in the coating. The additional film-forming resin can be selected from, for example, acrylic polymers, polyester polymers, polyurethane polymers, polyamide polymers, polyether polymers, polysiloxane polymers, copolymers thereof, and mixtures thereof. Generally, these polymers can be any polymers of these types made by any method known to those skilled in the art. The additional film-forming resin may be thermosetting or thermoplastic. In embodiments where the additional film-forming resin is thermosetting, the coating composition may further comprise a crosslinking agent that may be selected from any of the crosslinkers described above. The crosslinker may be the same or different from the crosslinker that is used to crosslink the non-aqueous dispersion. In certain other embodiments, a thermosetting film-forming polymer or resin having functional groups that are reactive with themselves are used; in this manner, such thermosetting coatings are self-crosslinking. The coating compositions may be solvent-based liquid compositions.

The coating compositions of the present invention can also comprise any additives standard in the art of coating manufacture including catalysts, organic cosolvents, colorants, plasticizers, abrasion-resistant particles, film strengthening particles, flow control agents, thixotropic agents, rheology modifiers, antioxidants, biocides, dispersing aids, adhesion promoters, clays, stabilizing agents, fillers, reactive diluents, and other customary auxiliaries, or combinations thereof. The colorants and abrasion-resistant particles can be, for example, those disclosed in United States Publication Number 2010/0055467A1, paragraphs 24-34, hereby incorporated by reference.

The coatings of the present invention may comprise 1 to 95, such as 20 to 90 or 60 to 80 weight percent, with weight percent based on total solid weight of the coating, of the non-aqueous dispersion of the present invention. The coating compositions of the present invention may also comprise 0 to 50, such as 5 to 40 or 10 to 30 weight percent, with weight percent based on total solids weight of the coating, of a crosslinker for the non-aqueous dispersion. Additional components, if used, may comprise up to 60 weight percent, such as up to 40 weight percent or up to 20 weight percent, with weight percent based on total solids weight of the coating.

In certain embodiments, the coatings of the present invention have high flexibility. By high flexibility is meant that the coated substrate can be bent, formed and/or drawn and the coating will remain intact; that is, it will not substantially crack, split and/or delaminate from the substrate. The flexibility of the coating can be measured, for example, by the wedge bend test method as described in the examples.

In certain embodiments, the coatings of the present invention are retortable. By “retortable” is meant that the coatings can withstand being processed at 130° C. in a closed retort for one hour while being immersed in an aqueous medium containing 3% salt and 2% acetic acid by weight. It has been surprisingly discovered that in certain embodiments retort resistance is high as compared to other polyester based systems, which are not typically known to have good retort resistance.

In certain embodiments, the non-aqueous dispersions and/or coatings of the present invention, may be substantially free, may be essentially free and/or may be completely free of bisphenol A and derivatives or residues thereof, including bisphenol A (“BPA”) and bisphenol A diglycidyl ether (“BADGE”). Such non-aqueous dispersions and/or coatings are sometimes referred to as “BPA non intent” because BPA, including derivatives or residues thereof, are not intentionally added but may be present in trace amounts because of impurities or unavoidable contamination from the environment. The non-aqueous dispersions and/or coatings of the present invention can also be substantially free and may be essentially free and/or may be completely free of bisphenol F and derivatives or residues thereof, including bisphenol F and bisphenol F diglycidyl ether (“BFDGE”). The term “substantially free” as used in this context means the non-aqueous dispersions and/or coatings contain less than 1000 parts per million (ppm), “essentially free” means less than 100 ppm and “completely free” means less than 20 parts per billion (ppb) of any of the above mentioned compounds, derivatives or residues thereof.

The present coatings can be applied to any substrates known in the art, for example, automotive substrates, industrial substrates, packaging substrates, architectural substrates, wood flooring and furniture, apparel, electronics including housings and circuit boards, glass and transparencies, sports equipment including golf balls, and the like. These substrates can be, for example, metallic or non-metallic. Metallic substrates include tin, steel, tin-plated steel, tin free steel, black plate, chromium passivated steel, galvanized steel, aluminum, aluminum foil. Non-metallic substrates include polymeric, plastic, polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), polyamide, wood, veneer, wood composite, particle board, medium density fiberboard, cement, stone, glass, paper, cardboard, textiles, leather both synthetic and natural, and other nonmetallic substrates. The substrate can be one that has been already treated in some manner, such as to impart visual and/or color effect. Accordingly, the coatings of the present invention can be a clear coat, a pigmented coat, can be used alone or in conjunction with other coatings such as a primer layer, basecoat, topcoat and the like.

The coatings of the present invention are particularly suitable for use as a packaging coating. The application of various pretreatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This is particularly true when the contents of the can are acidic in nature. The coatings applied to the interior of metal cans also help prevent corrosion in the headspace of the cans, which is the area between the fill line of the product and the can lid; corrosion in the headspace is particularly problematic with food products having a high salt content. Coatings can also be applied to the exterior of metal cans. Certain coatings of the present invention are particularly applicable for use with coiled metal stock, such as the coiled metal stock from which the ends of cans are made (“can end stock”), and end caps and closures are made (“cap/closure stock”). Since coatings designed for use on can end stock and cap/closure stock are typically applied prior to the piece being cut and stamped out of the coiled metal stock, they are typically flexible and extensible. For example, such stock is typically coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, typically by means of a pull tab. For caps and closures, the cap/closure stock is typically coated, such as by roll coating, and the cap or closure stamped out of the stock; it is possible, however, to coat the cap/closure after formation. Coatings for cans subjected to relatively stringent temperature and/or pressure requirements should also be resistant to cracking, popping, corrosion, blushing and/or blistering.

Accordingly, the present invention is further directed to a package coated at least in part with any of the coating compositions described above. A “package” is anything used to contain another item. It can be made of metal or non-metal, for example, plastic or laminate, and be in any form. In certain embodiments, the package is a laminate tube. In certain embodiments, the package is a metal can. The term “metal can” includes any type of metal can, container or any type of receptacle or portion thereof used to hold something. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends”, which are typically stamped from can end stock and used in conjunction with the packaging of beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two-piece cans” and “three-piece cans” as well as drawn and ironed one-piece cans; such one-piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating can be applied to the interior and/or the exterior of the package. For example, the coating can be rollcoated onto metal used to make a two-piece food can, a three-piece food can, can end stock and/or cap/closure stock. In some embodiments, the coating is applied to a coil or sheet by roll coating; the coating is then cured by heating or radiation and can ends are stamped out and fabricated into the finished product, i.e. can ends. In other embodiments, the coating is applied as a rim coat to the bottom of the can; such application can be by roll coating. The rim coat functions to reduce friction for improved handling during the continued fabrication and/or processing of the can. In certain embodiments, the coating is applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans.

The packages of the present invention can be coated with any of the compositions described above by any means known in the art, such as spraying, roll coating, dipping, flow coating and the like; the coating may also be applied by electrocoating when the substrate is conductive. The appropriate means of application can be determined by one skilled in the art based upon the type of package being coated and the type of function for which the coating is being used. The coatings described above can be applied over the substrate as a single layer or as multiple layers with multiple heating stages between the application of each layer, if desired. After application to the substrate, the coating composition may be cured by any appropriate means.

The present coatings can also be used as a packaging “size” coating, wash coat, spray coat, end coat, and the like.

The coatings can be applied in certain embodiments to a dry film thickness of 0.10 mils to 1.0 mils, such as from 0.10 to 0.50 mils, or from 0.15 to 0.30 mils Thicker or thinner dry film thicknesses are also within the scope of the present invention.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. For example, while the invention has been described in terms of “a” polyester stabilizer, “an” ethylenically unsaturated monomer, “an” organic solvent, and the like, mixtures of these and other components, including mixtures of non-aqueous dispersions, can be used. Also, as used herein, the term “polymer” is meant to refer to prepolymers, oligomers and both homopolymers and copolymers; the prefix “poly” refers to two or more. When ranges are given, any endpoints of those ranges and/or numbers within those ranges can be combined with the scope of the present invention. “Including”, “such as”, “for example” and like terms means “including/such as/for example but not limited to”.

### EXAMPLES

The following examples are intended to illustrate the invention and should not be construed as limiting the invention in any way. For example, while many of the examples use maleic anhydride in the formation of the polyester stabilizer, other polycarboxylic acids/anhydrides comprising a polymerizable double bond may be used.

### Example 1

A polyester was prepared from the following ingredients:

| Charge | Raw Material | Amount (g) |
|---|---|---|
| 1 | Trimethylol Propane | 1100.0 |
| | C36 Dimerized Fatty Acid | 1698.1 |
| | Cyclohexane Dicarboxylic Acid | 538.9 |
| | Butylstannoic Acid | 3.00 |
| | Triphenyl Phosphite | 3.00 |
| 2 | Maleic Anhydride | 225.2 |
| 3 | 1-Methoxypropan-2-ol | 830 |
| 4 | ISOPAR K¹ | 430 |

¹ISOPAR K is odorless mineral spirits, available commercially from Exxon-Mobil Chemical Company.

To a four necked, 5-liter reaction flask outfitted with a stirrer, gas inlet, thermometer and condenser was added the contents of Charge 1. The reaction mixture was heated in stages to 200° C. and held until the acid value was below 4. A slow nitrogen stream helped removed the water condensate. When an acid number <4 was reached, the reaction was cooled to <140° C. Charge 2 was then added and the reaction mixture was held for 1 h while the batch temperature was allowed to cool to 120° C. When infrared analysis confirmed the absence of anhydride peaks (approximately 1 h), Charges 3 and 4 were added and the mixture was allowed to cool. The resulting polyester resin had a solids content of 70.1% and a weight average molecular weight of 14,586 as measured by gel permeation chromatography.

### Example 2

A polyester was prepared from the following ingredients:

| Charge | Raw Material | Amount (g) |
|---|---|---|
| 1 | Trimethylol Propane | 460.0 |
| | C36 Dimerized Fatty Acid | 710.1 |
| | Adipic Acid | 182.9 |
| | Butylstannoic Acid | 1.31 |
| | Triphenyl Phosphite | 1.31 |
| 2 | Maleic Anhydride | 103.5 |
| 3 | Butyl Acetate | 453.3 |

To a four necked, 3-liter reaction flask outfitted with a stirrer, gas inlet, thermometer and condenser was added the contents of Charge 1. The reaction mixture was heated in stages to 195° C. and held until the acid value was below 4. A slow nitrogen stream helped removed the water condensate. When an acid number <4 was reached, the reaction was cooled to about 120° C. Charge 2 was then added and the reaction mixture was held until infrared analysis confirmed the absence of anhydride peaks (approximately 1 h). Charge 3 was added and the mixture was allowed to cool. The resulting polyester resin had a solids content of 73.2% and a weight average molecular weight of 10,156 as measured by gel permeation chromatography.

### Example 3

A non-aqueous dispersion was prepared from the following ingredients:

| Charge | Raw Material | Amount (g) |
|---|---|---|
| 1 | Polyester from Example 1 | 527.7 |
| | Solvent Blend A² | 278.2 |
| 2 | Ethylene Glycol Dimethacrylate | 3.4 |
| | 2-Hydroxyethyl Methacrylate | 51.1 |
| | Methyl Methacrylate | 25.5 |
| | Styrene | 5.1 |
| 3 | t-Butyl Per-3,5,5- | 0.5 |
| | trimethylhexanoate | |
| | Solvent Blend A | 3.3 |
| 4 | t-Butyl Per-3,5,5- | 2.96 |
| | trimethylhexanoate | |
| | Solvent Blend A | 47.2 |
| 5 | Solvent Blend A | 18.7 |
| 6 | t-Butyl Per-3,5,5- | 2.3 |
| | trimethylhexanoate | |
| | Solvent Blend A | 10.0 |
| 7 | Solvent Blend A | 5.0 |

²Solvent blend A was 71% butyl acetate and 29% ISOPAR K.

To a four necked, 2-liter reaction flask outfitted with a stirrer, gas inlet, thermometer and condenser was added the contents of Charge 1. The reaction mixture was heated to reflux (approximately 132° C.). A portion of Charge #2 (7.5 weight percent) and all of Charge #3 were added simultaneously to the reaction mixture over a period 10 min. The reaction mixture was held at reflux for 30 min, and then the remainder of Charge #2 along with all of Charge #4 was added over a period of 2 h. When the feeds were finished, the addition funnel that had held Charge #2 was rinsed with Charge #5, and this solvent was added to the reaction mixture. The reaction mixture was held at reflux for 1 h, and then Charge #6 was added over a period of 30 min. When the feed was finished, the addition funnel that had held Charge #6 was rinsed with Charge #7, and this solvent was added to the reaction mixture. The reaction mixture was held at reflux for an additional 1 h period, and then the resin was allowed to cool. The resulting non-aqueous dispersion had a solids content of 46.5% and a particle size of 1.41 micrometers as measured by light scattering on a Malvern MASTERSIZER instrument.

### Example 4

A non-aqueous dispersion was prepared from the following ingredients using the procedure described in Example 3:

| Charge | Raw Material | Amount (g) |
|---|---|---|
| 1 | Polyester from Example 1 | 399.1 |
| | Solvent Blend B³ | 389 |
| 2 | Ethylene Glycol Dimethacrylate | 4.4 |
| | 2-Hydroxyethyl Methacrylate | 66.2 |
| | Methyl Methacrylate | 33.1 |
| | Styrene | 6.6 |
| 3 | t-Butyl Per-3,5,5- | 0.4 |
| | trimethylhexanoate | |
| | Solvent Blend B | 3.67 |
| 4 | t-Butyl Per-3,5,5- | 2.54 |
| | trimethylhexanoate | |
| | Solvent Blend B | 47.2 |
| 5 | Solvent Blend B | 18.3 |
| 6 | t-Butyl Per-3,5,5- | 2.0 |
| | trimethylhexanoate | |
| | Solvent Blend B | 9.9 |
| 7 | Solvent Blend B | 5.1 |

³Solvent blend B was 67% butyl acetate and 33% ISOPAR K.

The resulting non-aqueous dispersion had a solids content of 39.0% and a particle size of 0.226 micrometers as measured by light scattering on a Malvern MASTERSIZER instrument.

### Example 5

A non-aqueous dispersion was prepared from the following ingredients using the procedure described in Example 3:

| Charge | Raw Material | Amount (g) |
|---|---|---|
| 1 | Polyester from Example 2 | 362.1 |
| | Solvent Blend C⁴ | 356.2 |
| 2 | Ethylene Glycol Dimethacrylate | 2.6 |
| | 2-Hydroxyethyl Methacrylate | 38.4 |
| | Methyl Methacrylate | 19.2 |
| | Styrene | 3.8 |
| 3 | t-Butyl Per-3,5,5- | 0.3 |
| | trimethylhexanoate | |
| | Solvent Blend C | 3.2 |
| 4 | t-Butyl Per-3,5,5- | 2.1 |
| | trimethylhexanoate | |
| | Solvent Blend C | 39.8 |
| 5 | Solvent Blend C | 16.0 |
| 6 | t-Butyl Per-3,5,5- | 1.6 |
| | trimethylhexanoate | |
| | Solvent Blend C | 8.7 |
| 7 | Solvent Blend C | 8.0 |

⁴Solvent blend C was 50% butyl acetate, 10% 1-methoxypropan-2-ol, and 40% ISOPAR K.

The resulting non-aqueous dispersion had a solids content of 40.7% and a particle size of 13.3 micrometers as measured by light scattering on a Malvern MASTERSIZER instrument.

### Example 6

A non-aqueous dispersion was prepared from the following ingredients using the procedure described in Example 3:

| Charge | Raw Material | Amount (g) |
|---|---|---|
| 1 | Polyester from Example 2 | 382.5 |
| | Solvent Blend D⁵ | 329.2 |
| 2 | Ethylene Glycol Dimethacrylate | 4.4 |
| | 2-Hydroxyethyl Methacrylate | 66.6 |
| | Methyl Methacrylate | 33.3 |
| | Styrene | 6.7 |
| 3 | t-Butyl Per-3,5,5- | 0.4 |
| | trimethylhexanoate | |
| | Solvent Blend D | 3.7 |
| 4 | t-Butyl Per-3,5,5- | 2.4 |
| | trimethylhexanoate | |
| | Solvent Blend D | 45.8 |
| 5 | Solvent Blend D | 18.4 |
| 6 | t-Butyl Per-3,5,5- | 1.9 |
| | trimethylhexanoate | |
| | Solvent Blend D | 10.0 |
| 7 | Solvent Blend D | 5.1 |

⁵Solvent blend D was 46% butyl acetate, 11% 1-methoxypropan-2-ol, and 43% ISOPAR K.

The resulting non-aqueous dispersion had a solids content of 43.0% and a particle size of 0.45 micrometers as measured by light scattering on a Malvern MASTERSIZER instrument.

### Example 7

Coatings were prepared from the NAD resins prepared as described above in Examples 3 though 6. All listed materials in the following table were added in order from top to bottom under agitation in half pint cans. All coatings were formulated with PHENODUR PR 516, from Cytec Surface Specialties, Inc., at 25% by weight on coating non-volatiles, and catalyzed with phosphoric acid, from Acros Organics, diluted to 10% by weight with isopropanol.

| Coating Example # | A | B | C | D |
|---|---|---|---|---|
| NAD Resin Example #3 | 55.83 | — | — | — |
| NAD Resin Example #4 | — | 66.59 | — | — |
| NAD Resin Example #5 | — | — | 63.82 | — |
| NAD Resin Example #6 | — | — | — | 60.40 |
| Butyl Cellosolve | 27.64 | 16.88 | 19.65 | 23.07 |
| PHENODUR PR 516 | 14.45 | 14.45 | 14.45 | 14.45 |
| 10% Phosphoric Acid | 2.08 | 2.08 | 2.08 | 2.08 |
| Totals | 100 | 100 | 100 | 100 |

All coatings were applied at 35% weight solids. Coatings were applied by drawing the coatings over either tin free steel (“TFS”) or electrolytic tin plate (“ETP”) using a #12 wire wound rod and baking them at 400° F. for 12 minutes. All coatings had a resultant dry coating weight of approximately 4 milligrams/square inch. Coatings were evaluated for their resistance to methyl ethyl ketone solvent by dousing a rag with the solvent and index finger rubbing it across the coating surface until the rag broke through the coating to the metal surface. The rag was re-doused with methyl ethyl ketone every twenty five double rubs across the coating surface. The number of double rubs to break through the coating was recorded for a maximum of 200 double rubs. Coating flexibility was evaluated in triplicate with a wedge bend test. A 4.5 inch long by 2 inch wide coated coupon was cut from the coated panel to intentionally have the metal grain run perpendicular to the length of the coated wedge bend test coupon. The length of the coupon was then bent over a ¼ inch metal dowel with the coated side out, and then placed in a piece of metal where a wedge had been removed to result in, after being impacted with approximately a 2000 gram weight dropped from twelve inches above the bent coupons, one end of the coupon to touch or impinge upon itself and the other end to stay open to the ¼ inch dowel bend. After being impacted, all bent coupons were immersed in an aqueous solution of 20% copper sulphate and 10% hydrochloric acid, by weight, for two minutes to etch the exposed metal substrate to facilitate rating them. Using a 1.0× microscope, coating flex was evaluated by measuring along the length of the bent coupon to the last area that had any open cracks or spotty failure from the impinged end. Reported % flex failed=(length of last crack or open spot/length of the entire coupon)×100. Coatings were also evaluated for their sterilization resistance to common food aqueous simulants like salt (2% by weight) and acid/salt (2% acetic acid/3% salt by weight and 1% salt/1% citric acid by weight). The retort conditions were 130° C. for 60 minutes, which are considered to be very harsh conditions. All coatings were rated for one or more of: adhesion 0 (nothing stuck) to 100% (nothing removed) using 3M's Scotch 610 tape; blush 0 (clear) to 4 (opaque); and corrosion 0 (none) to 4 (severe). The coatings of the present invention were compared to a standard commercial control, PPG2004877, commercially available form PPG Industries, Inc.

| | over ETP | | | | | | | | | | | |
|---|---|---|---|---|---|---|---|---|---|---|---|---|
| | | Wedge | | | over TFS | | | | | | | |
| | MEK | Bend | | | | | | 3% NaCl | | | 1% Salt | |
| | double | % failed | | | 2% NaCl | | | 2% Acetic | | | 1% Citric | |
| Coating | rubs | 1 | 2 | 3 | Adhesion | Blush | Corrosion | Adhesion | Blush | Corrosion | Adhesion | Blush |
| Epoxy | 95 | 17 | 18 | 16 | 100 | 1.0 | 0.5 | 100 | 1.5 | 1.5 | 100 | 0.5 |
| control | | | | | | | | | | | | |
| A | 135 | 22 | 19 | 17 | 95 | 0.5 | 1.0 | 100 | 1.0 | 2.0 | 100 | 0.5 |
| B | 165 | 22 | 22 | 22 | 90 | 0.5 | 1.0 | 100 | 1.0 | 1.5 | 100 | 0.5 |
| C | 85 | 23 | 18 | 20 | 100 | 0.5 | 1.0 | 100 | 1.0 | 2.0 | 100 | 0.5 |
| D | 110 | 22 | 22 | 23 | 100 | 0.5 | 1.5 | 100 | 1.0 | 2.0 | 100 | 0.5 |

As can be seen from the above table, the coatings prepared from the non-aqueous dispersions of the present invention have similar and useful coating properties as compared to the epoxy control. These results are somewhat surprising because the non-aqueous dispersions were prepared with copious amounts of polyester stabilizers, which typically adversely affect coating resistance properties, particularly in acidic simulants. Also surprising is that the polyester rich non-aqueous coatings match the resistance properties of the epoxy control coating when formulated with a reasonable amount of crosslinker. Normally, polyester rich coatings use a lot of crosslinker, sometimes upward of half of the coating solids, to begin to have some MEK and retort resistance properties. It has been discovered that coatings comprising non-aqueous dispersions as described herein that contain a relatively large amount of polyester can match the good flex and resistance properties of epoxy coatings even when formulated with lower amounts of crosslinker than would be expected.

Whereas particular embodiments of this invention have been described above for purposes of illustration, it will be evident to those skilled in the art that numerous variations of the details of the present invention may be made without departing from the invention as defined in the appended claims.

We claim:

1. A non-aqueous dispersion comprising a) the dispersion polymerization reaction product of an ethylenically unsaturated monomer and a polyester stabilizer, and b) an organic solvent.

2. The non-aqueous dispersion of claim 1, wherein the polyester stabilizer comprises a polymerizable double bond.

3. The dispersion of claim 2, wherein the polymerizable double bond is derived from maleic anhydride.

4. The dispersion of claim 1, wherein the ethylenically unsaturated monomer comprises a poly-ethylenically unsaturated monomer.

5. The dispersion of claim 1, wherein the ethylenically unsaturated monomer is substantially free of amine-functional monomers.

6. The dispersion of claim 1, wherein the dispersion polymerization reaction product comprises 70 weight percent or greater of the polyester stabilizer.

7. The dispersion of claim 1, wherein the polyester stabilizer has a weight average molecular weight of 7,000 to 20,000.

8. The dispersion of claim 1, wherein the polyester stabilizer comprises a polyol containing three hydroxyl groups per molecule.

9. The dispersion of claim 1, wherein the polyester stabilizer is the only stabilizer for the non-aqueous dispersion.

10. A coating comprising a non-aqueous dispersion comprising a) the dispersion polymerization reaction product of an ethylenically unsaturated monomer and a polyester stabilizer, and b) an organic solvent.

11. The coating of claim 10, wherein the coating composition is substantially free of bisphenol A.

12. The coating of claim 10, wherein the coating composition is essentially free of bisphenol A.

13. The coating of claim 10, wherein the coating is completely free of bisphenol A.

14. The coating of claim 10, further comprising a crosslinker.

15. The coating of claim 14, wherein the crosslinker comprises phenolic.

16. The coating of claim 14, wherein the crosslinker comprises 50 weight percent or less of the total solid weight of the coating.

17. A method for coating a substrate comprising applying to at least a portion of the substrate the coating of claim 10.

18. A substrate coated at least in part with the coating of claim 10.

19. The substrate of claim 18, wherein the substrate comprises a package.

20. The substrate of claim 19, wherein the package comprises a metal can.
